(19) United States
(12) Patent Application Publication
(10) Pub. No.: US 2024/0170176 A1
(43) Pub. Date: May 23, 2024

(54) WIRE CONDUCTOR AND INSULATED ELECTRIC WIRE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Yusuke MAEJIMA, Mie (JP); Yasuyuki OTSUKA, Mie (JP); Fumitoshi IMASATO, Mie (JP)

(21) Appl. No.: 18/283,608

(22) PCT Filed: Mar. 28, 2022
(86) PCT No.: PCT/JP2022/014777

§ 371 Date: Sep. 22, 2023

(30) Foreign Application Priority Data
Mar. 31, 2021 (JP) 2021-061050

(51) Int. Cl. H01B 1/02; H01B 7/08

(52) U.S. Cl. CPC H01B 1/02; H01B 7/08

(57) ABSTRACT

Provided are a wire conductor having high wire strength and high connection strength when the wire conductor is connected to a connector terminal even when the cross-sectional area of the conductor is smaller than 0.13 mm², and an insulated wire provided with such a wire conductor. A wire conductor 1 has a cross-sectional area of less than 0.13 mm², an electric resistance of not more than 660 mΩ/m, a tensile strength of at least 950 MPa, and a breaking elongation of at least 1.5%, and is to be used as a single wire.

### TECHNICAL FIELD

The present disclosure relates to a wire conductor and an insulated wire.

### BACKGROUND

Communication cables are connected to various communication devices via connectors in automobiles, and the size and the weight of connectors have been reduced along with a size reduction of devices. When the size of a connector is reduced, the diameter of the communication cable connected to the connector needs to be reduced as well. In Patent Document 1, a twisted wire conductor whose cross-sectional area is reduced to 0.13 mm² is used as a twisted wire conductor obtained by using bare wires made of a Cu-alloy containing Fe, for example.

### PRIOR ART DOCUMENT

### Patent Document

Patent Document 1: JP 2018-085344 A

Patent Document 2: JP 2018-037324 A

### SUMMARY OF THE INVENTION

### Problems to be Solved

If, as with the conductor used in Patent Document 1 above, a conductor has a cross-sectional area of about 0.13 mm², even when the diameter of conventional copper alloy twisted wires is reduced, the strength of the wires and the strength of connection when the connector is connected can be sufficiently ensured. However, in recent years, there is also demand for communication cables provided with conductors whose cross-sectional area is even smaller than 0.13 mm², along with a size reduction of connectors. It is difficult to reduce the diameter of a twisted wire conductor to a region where the cross-sectional area of the conductor is smaller than 0.13 mm², although it is conceivable to form such a conductor using a single wire. However, if a conventional copper alloy wire is directly used as a single wire, it will be difficult to ensure sufficient wire strength. Also, the strength of connection when a wire conductor is connected to a connector terminal tends to decrease.

In view of this, the present disclosure aims to provide a wire conductor having high wire strength and high connection strength when the wire conductor is connected to a connector terminal even when the cross-sectional area of the conductor is smaller than 0.13 mm², and an insulated wire provided with such a wire conductor.

### Means to Solve the Problem

A wire conductor according to this disclosure has a cross-sectional area of less than 0.13 mm², an electric resistance of not more than 660 mΩ/m, a tensile modulus of at least 950 MPa, and a breaking elongation of at least 1.5%, and is to be used as a single wire.

An insulated wire according to this disclosure includes the wire conductor and an insulating sheath covering an outer circumferential surface of one of the wire conductors.

### Effect of the Invention

The wire conductor and the communication cable according to this disclosure are a wire conductor having high wire strength and high connection strength when the wire conductor is connected to a connector terminal even when making the cross-sectional area of the conductor smaller than 0.13 mm², and an insulated wire provided with such a wire conductor.

### BRIEF DESCRIPTION OF THE DRAWINGS

FIG. 1 is a cross-sectional view of an insulated single wire according to an embodiment of this disclosure.

FIGS. 2A and 2B are cross-sectional views of flat wires. FIGS. 2A and 2B show flat wires having different forms.

FIG. 3 is a diagram showing results of evaluation of the relationship between physical properties and crimp strength of wire conductors. FIG. 3 shows physical properties of the wire conductors that include the tensile strength of the wire conductors at the top, the hardness of the core wires at the middle, and the hardness of the copper coating layer at the bottom. Also, the results obtained under low compression are shown on the left side, and the results obtained under high compression are shown on the right side in FIG. 3.

FIG. 4 is a diagram showing results of evaluation of the relationship between the tensile strength and the crimp strength of wire conductors when SUS 304H was used for core wires and SUS 304L was used for core wires. FIG. 4 also shows numerical values of the breaking elongation of the wire conductors. The relationship under low compression is shown at the top, and the relationship under high compression is shown at the bottom.

### DETAILED DESCRIPTION TO EXECUTE THE INVENTION

### Description of Embodiments of the Present Disclosure

First, embodiments of this disclosure will be described below.

A wire conductor according to this disclosure has a cross-sectional area of less than 0.13 mm², an electric resistance of not more than 660 mΩ/m, a tensile strength of at least 950 MPa, and a breaking elongation of at least 1.5%, and is to be used as a single wire.

The wire conductor has a large tensile strength of at least 950 MPa, and exhibits a breaking elongation of at least 1.5%. Therefore, the wire conductor has high wire strength and high connection strength when the wire conductor is connected to a connector terminal, even though the cross-sectional area of the wire conductor is as small as less than 0.13 mm². Further, the electric resistance of the wire conductor is reduced to not more than 660 mΩ/m, which is sufficiently low for use as a communication cable. Therefore, the wire conductor can be favorably used to form a communication cable connected to a small connector.

Here, the tensile strength of the wire conductor is preferably not more than 1300 MPa. As a result, if the strength of the wire conductor is excessively high when the wire conductor is connected to a connector terminal through crimping, the strength of the terminal material may decrease or the wire conductor cannot be sufficiently compressed to be in intimate contact with the terminal material. As a result, it is possible to keep the crimp strength of the crimped portion from decreasing.

The wire conductor may include a single core wire made of stainless steel and a copper coating layer made of copper or a copper alloy and covering an outer circumferential surface of the core wire. When the wire conductor includes a core wire made of stainless steel and a copper coating layer, the wire conductor overall can be more easily provided with a tensile strength of at least 950 MPa and a breaking elongation of at least 1.5%. Further, the copper coating layer contributes to readily reducing the electric resistance of the wire conductor to not more than 660 mΩ/m.

At a cross-section of the wire conductor, the hardness of the core wire is preferably at least 650 Hv and not more than 750 Hv, and the hardness of the copper coating layer is preferably at least 80 Hv and not more than 120 Hv. When the core wire and the copper coating layer forming the wire conductor have hardness within these ranges, the wire conductor overall has particularly high tensile strength and crimp strength.

The tensile strength of the core wire is preferably at least 2400 MPa and not more than 2800 MPa. As a result, the wire conductor has particularly high tensile strength and crimp strength.

Stainless steel forming the core wire preferably has a breaking elongation of at least 1.7% when heat treatment is performed for 1 hour at a temperature ranging from 150° C. to 400° C. When a core wire having high tensile strength and large elongation is used, the wire conductor overall tends to have high crimp strength. Also, even when the tensile strength of the wire conductor slightly fluctuates due to variations in the heat treatment conditions and the like, high crimp strength can be stably provided.

Stainless steel forming the core wire is preferably SUS 304H. SUS 304H has a high tensile strength and exhibits breaking elongation, and thus can be favorably used as a constituent material of the core wire.

An insulated wire according to this disclosure includes the wire conductor and an insulating sheath covering the outer circumferential surface of one of the wire conductors. This insulated wire has a small conductor cross-sectional area of less than 0.13 mm², and its diameter can be readily reduced. However, when the insulated wire having the above predetermined physical properties is used, the insulated wire exhibits high wire strength and high strength of connection with a terminal. Therefore, this insulated wire can be favorably used as a communication cable connected to a small connector in an automobile or the like.

A plurality of the wire conductors may be arranged parallel to each other, and the wire conductors are respectively covered by the insulating sheaths to form covering portions, and the covering portions are preferably connected to each other by one or more connection portions that are formed as single bodies with the insulating sheaths of the covering portions. When the plurality of wire conductors are arranged parallel to each other, the strength of the entire insulated wire is further improved. Also, when the plurality of wire conductors are arranged parallel to each other and the distance between wire conductors is stably maintained by connection portions, the resulting cable can be used as a communication cable with stable communication characteristics.

In this case, the distance between at least two adjacent wire conductors preferably ranges from 0.2 mm to 1.2 mm. As a result, these two wire conductors can be favorably used as a pair of wires for transmitting differential signals while maintaining sufficient insulation between conductors.

### Details of Embodiments of the Present Disclosure

Hereinafter, embodiments of this disclosure will be described in detail with reference to the drawings. Terms indicating the shape and arrangement of members, such as “parallel” and “perpendicular”, include not only geometrically strict concepts but also errors in a range that is generally allowable for communication cables in this specification. Further, the values of various physical properties are obtained through measurement in an atmosphere at room temperature (about 15° C. to 25° C.) in this specification.

<Overview of Wire Conductor and Communication Cable>

A communication cable according to an embodiment of this disclosure has a conductor cross-sectional area of less than 0.13 mm², and an electric resistance of not more than 660 mΩ/m. Further, the communication cable has a tensile strength of at least 950 MPa and a breaking elongation of at least 1.5%. An insulated wire according to an embodiment of this disclosure includes the wire conductor and an insulating sheath covering an outer circumferential surface of one of the wire conductors.

The wire conductors according to this embodiment of the disclosure are used as a single wire. Specifically, the wire conductors are used in a state in which each wire conductor is insulated, and are not used in a state in which a plurality of uninsulated wire conductors are twisted or bundled together. Also, the cross-sectional area of the wire conductor is less than 0.13 mm². When the wire conductor has such a small cross-sectional area, the diameter of the insulated wire can be reduced, and the wire conductor can be favorably used for connection to a small connector used in an automobile, for example. A small-diameter wire conductor having a cross-sectional area of less than 0.13 mm² can be more favorably used for communication than for electric conduction. From the viewpoint of facilitating a reduction in its diameter, the cross-sectional area of the conductor is more preferably not more than 0.10 mm². There is no particular limitation on the lower limit of the cross-sectional area of the conductor. However, from the viewpoint of keeping its strength from decreasing through an excessive reduction of its diameter, for example, its lower limit is preferably set to at least 0.02 mm², for example. It is possible to favorably adopt a conductor cross-sectional area of 0.05 mm². Also, the electric resistance of the wire conductor is not more than 660 mΩ/m. When the electric resistance of the wire conductor is not more than 660 mΩ/m, the wire conductor has sufficient conductivity for a communication cable. More preferably, the electric resistance of the wire conductor is not more than 600 mΩ/m.

The wire conductor according to this embodiment has a tensile strength of at least 950 MPa. When the wire conductor has a tensile strength of at least 950 MPa, the wire conductor, which is a small-diameter single wire, and the insulated wire including the wire conductor can have sufficiently high wire strength. Further, when the wire conductor is crimped and connected to a connector terminal, the crimped portion can have high connection strength. That is, the wire conductor compressed at the crimped portion is unlikely to break. From the viewpoint of further improving these effects, the tensile strength of the wire conductor is preferably at least 970 MPa, at least 1000 MPa, or at least 1050 MPa. The tensile strength of a wire conductor can be evaluated as tensile strength at break through tensile testing conforming to JIS Z 2241.

The upper limit of the tensile strength of the wire conductor is not particularly specified. However, even if its tensile strength is excessively high, the connection strength at a portion connected to the connector terminal may decrease. This is because if the wire conductor has high strength and is excessively hard, the strength of a material of the connector terminal may decrease when the wire conductor is crimped and connected to the connector terminal, and the wire conductor cannot be sufficiently deformed, for example, and thus the wire conductor cannot be firmly held by the connector terminal, resulting in a decrease in the connection strength. From the viewpoint of avoiding such situations and ensuring high connection strength, the tensile strength of the wire conductor is preferably not more than 1300 MPa, not more than 1180 MPa, or not more than 1080 MPa.

Further, the wire conductor according to this embodiment has a breaking elongation of at least 1.5%. When the wire conductor has a tensile strength of at least 950 MPa and a breaking elongation of at least 1.5% and the wire conductor is connected to a crimp terminal, the crimped portion can have high crimp strength utilizing elongation of the wire conductor. Further, when the wire conductor has sufficiently high breaking elongation, high crimp strength can be stably obtained even when the tensile strength of the wire conductor fluctuates due to variations in the heat treatment conditions and the like. From the viewpoint of further improving these effects, the breaking elongation of the wire conductor is preferably at least 1.8%, at least 2.0%, or at least 2.2%. The breaking elongation of a wire conductor can be evaluated through tensile testing conforming to JIS Z 2241.

When the wire conductor has a tensile strength of at least 950 MPa and a breaking elongation of at least 1.5%, the crimped portion can have high crimp strength of at least 30 N, for example. As a result, when the wire conductor is connected to a connector terminal, high connection strength can be obtained. The crimp strength is preferably at least 40 N. The crimp strength of the wire conductor can be evaluated as the maximum force applied until the wire conductor breaks at its crimped portion when the wire conductor is pulled in a state in which the wire conductor is crimped and connected to the crimp terminal. The crimped portion of the wire conductor according to this embodiment breaks because the wire conductor breaks inside the crimp terminal but a portion where the crimp terminal and the wire conductor are joined together does not detach therefrom. Therefore, its crimp strength can be determined as a parameter that is less dependent on the type of crimp terminal and a crimping method. The wire conductor is held by a crimp terminal made of a copper alloy and compressed from opposite directions in a region of the wire conductor having a length of 1.6 to 3.0 mm along its axial direction, and thus the wire conductor is crimped and connected to the crimp terminal. Then, tensile testing may be performed, for example.

### Specific Examples of Wire Conductor and Insulated Wire: Wire Conductor Having Two-Layer Structure

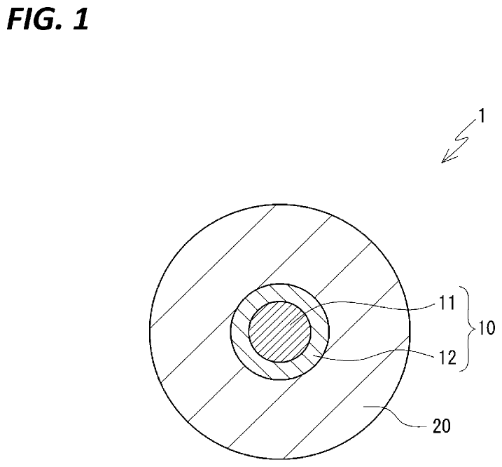

Next, a wire conductor having a two-layer structure including a core wire and a coating layer will be described as an example of a single wire conductor having an electric resistance of not more than 660 mΩ/m, a tensile strength of at least 950 MPa, and a breaking elongation of at least 1.5% when the conductor has a cross-sectional area of less than 0.13 mm² as described above, and an insulated wire provided with such a wire conductor will also be described. FIG. 1 is a cross-sectional view of an insulated wire 1 including such a wire conductor 10. In the insulated wire 1, an insulating sheath 20 is formed by covering an outer circumferential surface of one wire conductor 10.

The wire conductor 10 includes a single core wire 11, and a copper coating layer 12 covering the outer circumferential surface of the core wire 11. The core wire 11 and the copper coating layer 12 are joined into a single body. The core wire 11 is made of stainless steel (SUS). There is no particular limitation on the type of SUS, and austenitic SUS, in particular, SUS 304H and SUS 304L can be favorably used. The copper coating layer 12 is made of copper or a copper alloy. Preferably, the copper coating layer 12 is made of pure copper that does not contain any additive element other than inevitable impurities. Although another type of layer may be arranged between the core wire 11 and the copper coating layer 12 in order to increase bondability between the core wire 11 and the copper coating layer 12, for example, it is preferable that the copper coating layer 12 is formed in direct contact with the surface of the core wire 11.

Here, component compositions of SUS 304H and SUS 304L are listed in Table 1 below. SUS 304H and SUS 304L differ from each other in the C content and the Ni content.

TABLE 1

| | Content (mass %) | | | | | | | |
|---|---|---|---|---|---|---|---|---|
| | C | Si | Mn | P | S | Cr | Ni | Fe |
| SUS 304H | ≤0.08 | ≤1.00 | ≤2.00 | ≤0.045 | ≤0.030 | 18.0-20.00 | 8.00-10.50 | remaining portion |
| SUS 304L | ≤0.030 | ≤1.00 | ≤2.00 | ≤0.045 | ≤0.030 | 18.0-20.00 | 9.00-13.00 | remaining portion |

The wire conductor 10 according to this embodiment includes the core wire 11 made of SUS, which has high material strength. Therefore, the wire conductor 10 overall has a high tensile strength of at least 950 MPa, for example. Therefore, even when the wire conductor is used as a single wire or has a small diameter, the wire conductor has higher strength than a conventional and ordinary wire conductor made of a copper alloy. It is also possible to increase the strength of connection when the wire conductor is connected to the connector. Specific properties of the core wire 11 will be described later in detail. From the viewpoint of the wire conductor 10 exhibiting sufficient strength, the outer diameter of the core wire 11 is at least 0.11 mm, and more preferably at least 0.12 mm From the viewpoint of ensuring a sufficient thickness of the copper coating layer 12 while maintaining the small diameter of the wire conductor 10, for example, the outer diameter of the core wire 11 is preferably not more than 0.17 mm.

In the wire conductor 10, the copper coating layer 12 functions to support the flow of electric current. The SUS forming the core wire 11 is not a highly conductive metal. However, the copper coating layer 12 made of copper or a copper alloy, which is a highly conductive metal, is provided on the outer circumferential surface of the core wire 11 in order to ensure sufficient conductivity of the wire conductor 10 overall. The thickness of the copper coating layer 12 is determined such that the overall electric resistance of the wire conductor 10 is not more than 660 mΩ/m, or preferably not more than 600 mΩ/m. There is no particular limitation on the electric resistance of the wire conductor 10. From the viewpoint of preventing the copper coating layer 12 from being excessively thick, for example, the electric resistance of the wire conductor 10 is preferably at least 500 mΩ/m, for example. The thickness of the copper coating layer 12 is preferable at least 40 μm and not more than 70 μm.

The insulating sheath 20 is formed using an organic polymer as a base material. There is no particular limitation on the type of organic polymer, and it is possible to use olefin-based polymers such as polyolefins and olefin-based copolymers, halogen-based polymers such as polyvinyl chloride, various elastomers, rubber, and the like. Various additives may be added to an organic polymer as appropriate. There is no particular limitation on the thickness of the insulating sheath 20. From the viewpoint of imparting sufficient insulation and the like, the thickness of the insulating sheath 20 is preferably at least 0.1 mm, for example. On the other hand, from the viewpoint of facilitating a reduction in the diameter of the insulated wire 1, the thickness of the insulating sheath 20 is preferably not more than 0.25 mm

<Properties of Wire Conductor Having Two-Layer Structure>

Next, the properties of the wire conductor 10 having a two-layer structure including the SUS core wire 11 and the copper coating layer 12 mentioned above will be described below in detail.

The wire conductor 10 includes the core wire 11 made of SUS and thus has high strength. Specifically, as described above, the overall tensile strength of the wire conductor 10 is at least 950 MPa. The tensile strength of the wire conductor 10 is preferably at least 970 MPa, at least 1000 MPa, or at least 1050 MPa. Further, the tensile strength of the wire conductor 10 is preferably not more than 1300 MPa, not more than 1180 MPa, or not more than 1080 MPa.

The overall breaking elongation of the wire conductor 10 is mainly dependent on the breaking elongation of the core wire 11 made of SUS. However, the copper coating layer 12 is made of copper or a copper alloy, which is a metal that is more flexible than SUS, and thus contributes to increasing the breaking elongation of the wire conductor 10. As described above, the breaking elongation of the wire conductor 10, which is a composite of the core wire 11 and the copper coating layer 12, is at least 1.5%. The breaking elongation of the wire conductor 10 is preferably at least 1.8%, at least 2.0%, or at least 2.2%.

The materials of the core wire 11 made of SUS and the copper coating layer 12 may have any properties as long as the wire conductor 10 overall exhibits the tensile strength and breaking elongation described above. However, the core wire 11 preferably has a hardness of at least 650 Hv, or at least 670 Hv at a cross-section of the wire conductor 10. Also, the core wire 11 alone preferably has a tensile strength of at least 2400 MPa, or at least 2500 MPa. When the core wire 11 has a hardness and tensile strength greater than or equal to these values, the overall strength of the wire conductor 10 tends to increase. On the other hand, the hardness of the core wire 11 is preferably not more than 750 Hv, or not more than 700 Hv. Also, the core wire 11 alone preferably has a tensile strength of not more than 2800 MPa, or not more than 2600 MPa. When the hardness and the tensile strength of the SUS core wire 11 are suppressed to not more than these values, its crimp strength is likely to be kept from decreasing through an excessive increase in the strength of the wire conductor 10.

Also, when heat treatment (annealing after wire drawing) is performed on the core wire 11 alone made of SUS for 1 hour at a temperature ranging from 150° C. to 400° C., its breaking elongation is preferably at least 1.7%, or at least 2.2%. As a result, the wire conductor 10 overall tends to have the breaking elongation described above. Examples of a SUS material that provides the core wire 11 with a breaking elongation of at least 1.7%, or at least 2.2% under the above heat treatment conditions, include SUS 304H.

The hardness of the copper coating layer 12 is preferably at least 80 Hv. Furthermore, the hardness of the copper coating layer 12 is preferably not more than 160 Hv, or not more than 120 Hv. The overall strength of the wire conductor 10 is greatly affected by the strength of the core wire 11, and the strength of the copper coating layer 12 also contributes to the overall strength of the wire conductor 10. Therefore, when the hardness of the copper coating layer 12 is in the above range, the overall tensile strength and crimp strength of the wire conductor 10 tend to be effectively increased. The hardness of the SUS core wire 11 and the copper coating layer 12 can be measured using a micro Vickers hardness tester or the like, at a cross-section obtained by cutting the wire conductor 10 perpendicularly to its axial direction. At this time, a measurement is performed at about five positions for the core wire and the copper coating layer, and their averages need only be used as their hardness.

<Method for Manufacturing Wire Conductor Having Two-Layer Structure>

With a method for manufacturing the wire conductor 10 having the above two-layer structure, the SUS core wire 11 having a predetermined diameter is manufactured through wire drawing, and then the copper coating layer 12 need only be formed on the surface of the core wire 11 through plating or vapor deposition, for example. Alternatively, the wire conductor 10 can also be manufactured by fitting a ring-shaped copper member, which will serve as the copper coating layer 12, around the SUS member, which will serve as the core wire 11, and drawing them together into a single member with a predetermined diameter.

Heat treatment (annealing) is preferably performed on the wire conductor 10 having the copper coating layer 12 on the surface of the SUS core wire 11 obtained in this manner. The copper coating layer 12 is softened mainly through heat treatment. Heat treatment conditions need to be set such that the wire conductor 10 overall has a desired tensile strength, hardness, and breaking elongation. The heat treatment temperature ranges from 100° C. to 400° C., for example. The heat treatment may be performed at a temperature ranging from 250° C. to 400° C., for example. The heat treatment may be performed through continuous softening for resistive heating the wire conductor 10, or batch softening for heating the wire conductor 10 in a batch furnace at a predetermined temperature.

<Insulated Wire with Another Form—Flat Wire>

The wire conductor according to an embodiment of this disclosure such as the wire conductor 10 having a two-layer structure may be used in any form, and is not limited to a simple insulated wire 1 in which the entire circumferential surface of one wire conductor 10 as shown in FIG. 1 is covered by the insulating sheath 20. A flat wire will be briefly described as an example in which an insulated wire according to another embodiment is formed using wire conductors 10 according to the embodiment.

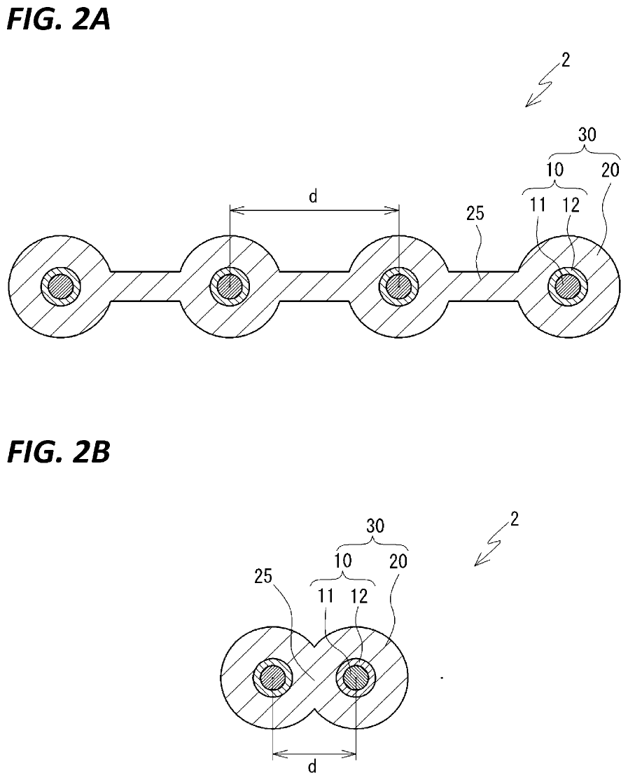

Cross-sections of flat wires 2 are shown in FIGS. 2A and 2B. FIGS. 2A and 2B show flat wires having different forms. The flat wire 2 includes a plurality of the wire conductors 10 according to an embodiment of this disclosure described above. The number of wire conductors 10 is not particularly specified, and it is possible to favorably adopt a number ranging from 2 to 8. In particular, the number of wire conductors 10 may be an even number such that pairs of wires can be formed.

In the flat wire 2, a plurality of wire conductors 10 are arranged parallel to each other in one direction, with their axial directions arranged parallel to each other. The outer circumferential surfaces of the wire conductors 10 arranged side-by-side are respectively covered by insulating sheaths 20, and thus a plurality of covering portions 30 each of which is constituted by the wire conductor 10 and the insulating sheath 20 are formed. Also, the covering portions 30 are connected to each other by connection portions 25. The insulating sheaths 20 forming the covering portions 30 and the connection portions 25 are formed as a single body using the same material. In the embodiment shown in FIG. 2A, connection portions 25 are formed by connecting covering portions 30 having a substantially circular cross-section. On the other hand, in the embodiment shown in FIG. 2B, adjacent covering portions 30 are directly joined together such that their substantially circular cross-sectional shapes overlap each other, and portions of the insulating sheaths 20 forming the covering portions 30 function as a connection portion 25. From the viewpoint of ensuring the flexibility of the flat wire 2 in any form and facilitating tearing of the flat wire 2 during terminal processing, for example, the thickness of the connection portion 25 (its length in a direction orthogonal to the direction in which the wire conductors 10 are arranged parallel to each other) is preferably smaller than the diameter of the covering portion 30.

There is no particular limitation on the distance between wire conductors 10 arranged parallel to each other. A distance d between adjacent wire conductors 10 (the distance between the centers of the wire conductors 10) may be at least 0.2 mm, at least 0.4 mm, or at least 0.8 mm. As a result, sufficient insulation between wire conductors 10 can be ensured. In particular, in the embodiment shown in FIG. 2A, the distance d between adjacent wire conductors 10 is preferably at least 0.4 mm. On the other hand, the distance d between at least two adjacent wire conductors 10 is preferably not more than 1.2 mm, or not more than 1.0 mm. As a result, these two wire conductors 10 can be favorably used as a pair of wires for transmitting differential signals while ensuring the required characteristic impedance. Note that if the flat wire 2 includes three or more wire conductors 10, the distance d between the wire conductors 10 may be longer than 1.2 mm, or all the wire conductors 10 may be arranged at equal intervals of not more than 1.2 mm at portions other than the two wire conductors 10 forming the pair of wires.

Use of the flat wire 2 makes it possible to collectively connect a plurality of wire conductors 10 to a connector having a plurality of terminals arranged side-by-side. As described above, the wire conductor 10 according to an embodiment of this disclosure has high strength. The overall strength of the flat wire 2 can be further increased by arranging a plurality of wire conductors 10 parallel to each other. Also, when a twisted pair wire is formed by twisting together independent insulated wires 1 shown in FIG. 1, it tends not to stably maintain its twisted structure because the wire conductor 10 has high rigidity due to the high strength of the wire conductor 10. However, when the flat wire 2 is formed by arranging a plurality of wire conductors 10 side-by-side and the distance d between wire conductors 10 is kept constant using connection portions 25, differential signals can be stably transmitted.

### Examples

Examples will be described below. Note that the present invention is not limited to these examples. Hereinafter, samples are produced and evaluated at room temperature in the atmosphere, unless otherwise stated.

(1) Relationship Between Strength and Crimp Strength of Wire Conductor Having Two-Layer Structure

First, the relationship regarding the tensile strength of a wire conductor having a two-layer structure including a SUS core wire and a copper coating layer and the hardness of its constituent portions, and the crimp strength of the terminal crimped portion was examined

<Production of Samples>

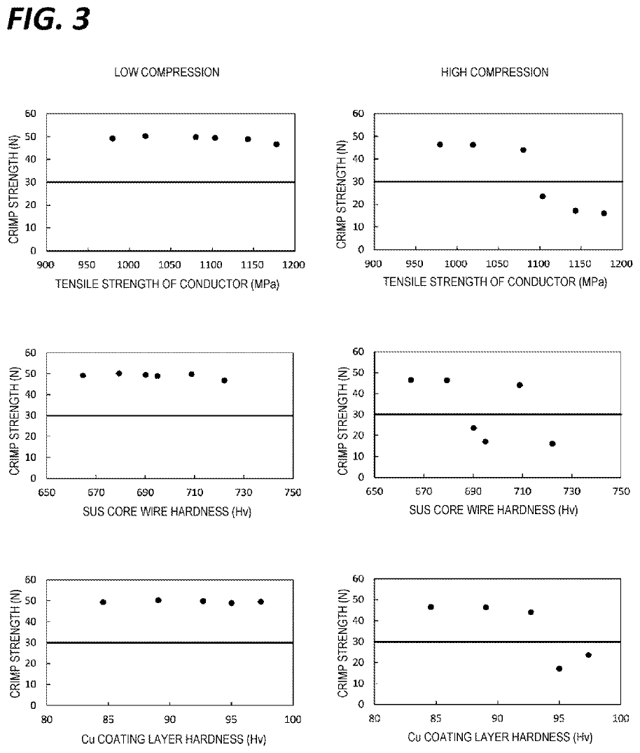

A wire conductor having a core wire made of SUS 304H and a copper coating layer made of pure copper was produced. The outer diameter of the core wire was 00.16 mm, and the thickness of the copper coating layer was 45 μm. The overall outer diameter of the wire conductor was 00.25 mm and the cross-sectional area of its conductor was 0.05 mm². Heat treatment was performed on the obtained wire conductor through continuous softening. Heat treatment conditions were set such that predetermined tensile strength shown on the horizontal axis at the top in FIG. 3 can be obtained. The heating temperature was within a range of about 100° C. to 400° C. Samples were also separately produced through batch heating for 1 hour at multiple temperatures ranging from 100° C. to 400° C. The electric resistance of each wire conductor was not more than 660 mΩ/m even when the wire conductor was heat-treated under any of the conditions. A copper alloy conductor (tensile strength: 740 MPa, breaking elongation: 2.1%) having a cross-sectional area of 0.05 mm² was also prepared as a reference sample,

<Evaluation Method>

Tensile Strength of Wire Conductor

The tensile strength at break of the produced wire conductors was evaluated through tensile testing conforming to JIS Z 2241. The time when the wire conductor broke was regarded as the breakage time. The distance between evaluation points was 250 mm, and the tensile speed was 50 mm/min in measurement.

Hardness of Each Portion

Each of the produced wire conductors was cut perpendicularly to its axial direction, and the hardness of the core wire and the copper coating layer was measured at its cross-section. Hardness was measured using a micro Vickers hardness tester. A measurement was performed at five positions of the core wire and the copper coating layer, and the averages of the obtained values for the core wire and the copper coating layer were recorded.

Crimp Strength

The produced wire conductors were cut to a length of 104 mm, and crimped and connected to a crimp terminal to prepare conductors provided with the terminal. Crimp terminals made of a copper alloy were used, and when being crimped and connected to the crimp terminals, the wire conductors were held and compressed from opposite directions in a region of the wire conductor having a length of 1.6 to 3.0 mm along its axial direction. Two types of crimped portions, namely, a low-compression portion and a high-compression portion, were formed by changing the degree of compressing the conductor. Low compression is applied to a portion where an ordinary connector terminal and a wire conductor are connected to each other, and a high compression state refers to a state in which a wire conductor is compressed under more severe conditions than ordinary conditions.

A crimp terminal was fixed to the obtained conductor provided with the terminal, and the wire conductor was pulled. Then, the maximum force applied until the wire conductor broke at its crimped portion was recorded as crimp strength. The pulling speed was 100 mm/min Note that the crimped portions of all the samples broke because the wire conductors broke inside the crimp terminals, but the wire conductors did not detach from the crimp terminals.

<Results of Test>

FIG. 3 shows the relationship between various properties (horizontal axis) and crimp strength (vertical axis) of the wire conductors, which were heat-treated through continuous softening. The properties shown on the horizontal axis include the overall tensile strength of the wire conductors at the top, the hardness of the SUS core wires at the middle, and the hardness of the copper coating layers at the bottom. Also, the results obtained under low compression are shown on the left side, and the results obtained under high compression are shown on the right side. The solid lines indicate a crimp strength of 30 N in FIG. 3.

First, the results obtained under low compression were as follows. Based on the relationship between the tensile strength and the crimp strength of the wire conductor, a crimp strength of at least 30 N was obtained in the entire tensile strength range of at least 950 MPa. At that time, the hardness of the corresponding SUS core wire and the hardness of the copper coating layer were respectively at least 650 Hv and at least 80 Hv. Further, although no graph is shown for this, sample conductors heat-treated through batch softening also had a tensile strength of 1050 MPa to 1300 MPa and a crimp strength of at least 30 N.

Then, the results obtained under high compression were as follows. In this case, the high-compression portions had a crimp strength of at least 30 N at the tensile strength of a wire conductor ranging from about 950 MPa to about 1080 MPa. The crimp strength decreased when the tensile strength was higher than 1080 MPa. This is because the material strength of the crimp terminal was reduced due to the hardness of the wire conductor, and the wire conductor was not firmly held by the crimp terminal. Note that the crimp strength of the copper alloy conductor of the reference sample was 23.6 N under low compression, and 25.4 N under high compression.

(2) Examination of Constituent Material of Core Wire in Wire Conductor Having Two-Layer Structure

Here, the influence of elongation of SUS forming a core wire in a wire conductor having a two-layer structure on properties of the wire conductor was examined

<Production of Samples>

Although the core wire made of SUS 304H was used in the above test (1), a wire conductor was produced in the same manner using a core wire made of SUS 304L, instead of SUS 304H. The conditions under which heat treatment was performed through continuous softening were set such that tensile strength obtained when SUS 304H was used and tensile strength obtained when SUS 304L was used were substantially the same. Also, a SUS 304H core wire and a SUS 304L core wire that were not provided with a copper coating layer were separately subjected to heat treatment through batch softening under the same conditions as for the wire conductor provided with the copper coating layer.

<Evaluation Method>

Tensile Strength and Crimp Strength

The tensile strength and the crimp strength of sample wire conductors heat-treated through continuous softening were evaluated using the same method as in the above test (1).

Breaking Elongation

The breaking elongation of the samples heat-treated through continuous softening and batch softening was evaluated through tensile testing conforming to JIS Z 2241. Their electric resistance was also measured using four-terminal sensing.

<Results of Evaluation>

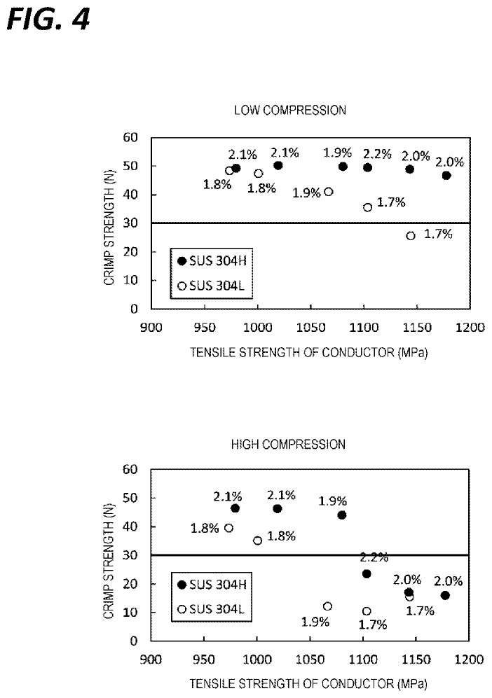

FIG. 4 shows the relationship between the overall tensile strength and the overall crimp strength of wire conductors when SUS 304H was used for a core wire and SUS 304L was used for a core wire. Also, FIG. 4 shows breaking elongation values of the wire conductors in the vicinities of data points. The relationship under low compression is shown at the top, and the relationship under high compression is shown at the bottom. The data regarding SUS 304H shown in FIG. 4 is the same as that shown in FIG. 3.

According to FIG. 4, in the low compression state, when the core wire is made of SUS 304H or SUS 304L, a crimp strength of at least 30 N can be obtained in a region where the wire conductor has at least 950 MPa and a breaking elongation of at least 1.5%. Based on this, use of a wire conductor having a tensile strength of at least 950 MPa and a breaking elongation of at least 1.5% makes it possible to achieve sufficiently high crimp strength at a portion connected to an ordinary terminal. It seems that when the wire conductor has high elongation during crimping, crimp strength can be improved.

Further, a comparison between the results of the SUS 304H and the SUS 304L in detail reveals that, under low compression, SUS 304H had a crimp strength of at least 30 N at all data points, whereas SUS 304L had low crimp strength in a region where the tensile strength was high. That is, SUS 304H had a crimp strength of at least 30 N in a wider region, compared to SUS 304L. Under high compression as well, SUS 304H had a crimp strength of at least 30 N in a wider region.

When a constituent material of the core wire is SUS 304H, higher crimp strength can be stably obtained in a wider tensile strength range, compared to SUS 304L. The difference in crimp strength between SUS 304H and SUS 304L can be correlated with the difference in elongation of both materials SUS 304H and SUS 304L. Based on the values of breaking elongation shown in FIG. 4, SUS 304H tends to have higher breaking elongation than SUS 304L even though they have almost the same tensile strength. From the viewpoint of further examining the difference in breaking elongation between two types of SUS in detail, Table 2 below shows breaking elongation values of the two materials of the core wire alone and the core wire provided with the copper coating layer measured after batch softening at various temperatures. Electric resistance values measured when the copper coating layer was provided are also listed in Table 2.

TABLE 2

| | | | | | Electric resistance | |
|---|---|---|---|---|---|---|
| | Breaking elongation (%) | | | | (mΩ/m) | |
| | | | after formation of | | after formation of | |
| | core wire alone | | Cu coating layer | | Cu coating layer | |
| Heat treatment | SUS | SUS | SUS | SUS | SUS | SUS |
| conditions | 304H | 304L | 304H | 304L | 304H | 304L |
| Before heat | 2.5 | 2.8 | 2.4 | 2.4 | 569.2 | 580.8 |
| treatment | | | | | | |
| 100° C. × 1 h | 2.4 | 2.4 | 2.2 | 2.2 | 559.4 | 567.2 |
| 150° C. × 1 h | 2.3 | 2.0 | 2.2 | 2.0 | 555.5 | 563.8 |
| 200° C. × 1 h | 2.2 | 2.0 | 2.2 | 1.9 | 550.8 | 561.5 |
| 250° C. × 1 h | 2.4 | 1.8 | 2.0 | 1.7 | 532.6 | 545.9 |
| 300° C. × 1 h | 2.3 | 2.0 | 2.1 | 1.8 | 526.9 | 537.3 |
| 350° C. × 1 h | 2.2 | 1.9 | 2.1 | 1.8 | 525.5 | 533.6 |
| 400° C. × 1 h | 2.2 | 1.8 | 2.1 | 1.8 | 525.0 | 535.0 |

According to Table 2, the core wire alone made of SUS 304H had larger breaking elongation obtained through heat treatment, compared to the core wire alone made of SUS 304L. When heat treatment was performed for 1 hour at a temperature ranging from 150° C. to 400° C., SUS 304L had a breaking elongation of not more than 2.0%, whereas SUS 304H had a breaking elongation of at least 2.2%. Also, SUS 304H tends to exhibit greater elongation even in the state in which the copper coating layer was formed on the outer circumferential surface of the core wire. When heat treatment was performed for 1 hour at a temperature ranging from 200° C. to 400° C., SUS 304L had a breaking elongation of not more than 1.9%, whereas SUS 304H had a breaking elongation of at least 2.0% in the entire range.

It seems that SUS 304H exhibits larger breaking elongation after heat treatment than SUS 304L, which is related to the phenomenon shown in FIG. 4 in which SUS 304H provides high crimp strength over a wider tensile strength range. It is also confirmed based on Table 2 that the electric resistance values of the wire conductors obtained under all of the heat treatment conditions were suppressed to not more than 660 mΩ/m when either material, SUS 304H or SUS 304L, was used.

The present invention is not merely limited to the above embodiments, and various modifications can be made without departing from the gist of the present invention.

Note that the configuration of the flat wire described above can also be applied to other wire conductors than the wire conductors according to the embodiments of this disclosure. If a conventionally used copper alloy wire such as a Cu—Sn alloy wire is used, for example, the effect of improving strength and reducing the diameter of the wire conductors can be obtained by arranging small-diameter wire conductors having a cross-sectional area of less than 0.32 mm² parallel to each other. That is, in order to ensure the wire strength when the diameters of a plurality of wire conductors in an insulated wire are reduced, the insulated wire may be configured as follows.

The insulated wire includes:
a plurality of single wire conductors having a cross-sectional area of less than 0.32 mm² and arranged parallel to each other,
a covering portion is formed by covering an outer circumferential surface of each of the wire conductors by an insulating sheath, and
the covering portions are connected to each other by one or more connection portions that are formed as single bodies with the insulating sheaths of the covering portions.

The distance between at least two adjacent wire conductors in the insulated wire preferably ranges from 0.2 mm to 1.2 mm. In particular, the distance is preferably not more than 1.0 mm. In addition, the above-described embodiments can be favorably applied to a configuration relating to a flat wire.

### LIST OF REFERENCE NUMERALS

1 Insulated wire
2 Flat wire
10 Wire conductor
11 Core wire
12 Copper coating layer
20 Insulating sheath
25 Connection portion
30 Covering portion
d Distance between wire conductors

1. A wire conductor for use as a single wire,
wherein the wire conductor has a cross-sectional area of less than 0.13 mm²,
an electric resistance of not more than 660 mΩ/m,
a tensile strength of at least 950 MPa and not more than 1080 MPa, and
a breaking elongation of at least 1.5%.

2. The wire conductor according to claim 1, comprising:
a single core wire made of stainless steel; and
a copper coating layer made of copper or a copper alloy and covering an outer circumferential surface of the core wire.

3. The wire conductor according to claim 2,
wherein, at a cross-section of the wire conductor,
the core wire has a hardness of at least 650 Hv and not more than 750 MPa, and
the copper coating layer has a hardness of at least 80 Hv and not more than 120 Hv.

4. The wire conductor according to claim 2,
wherein the core wire has a tensile strength of at least 2400 MPa and not more than 2800 MPa.

5. The wire conductor according to claim 2,
wherein the stainless steel forming the core wire has a breaking elongation of at least 1.7% when heat treatment is performed for 1 hour at a temperature ranging from 150° C. to 400° C.

6. The wire conductor according to claim 2,
wherein the stainless steel forming the core wire is SUS 304H.

7. An insulated wire comprising:
the wire conductor according to claim 1; and
an insulating sheath covering an outer circumferential surface of one of the wire conductors.

8. The insulated wire according to claim 7,
wherein a plurality of the wire conductors are arranged parallel to each other,
a covering portion is formed by covering an outer circumferential surface of each of the wire conductors with the insulating sheath, and
the covering portions are connected to each other by one or more connection portions that are formed as single bodies with the insulating sheaths of the covering portions.

9. The insulated wire according to claim 8,
wherein the distance between at least two adjacent wire conductors ranges from 0.2 mm to 1.2 mm.

10. (canceled)
